(19) United States
(12) Patent Application Publication
(10) Pub. No.: US 2009/0257235 A1
(43) Pub. Date: Oct. 15, 2009

(54) Shade support for a spiral shaped compact fluorescent light

(76) Inventor: Daniel J. Wipper, McHenry, IL (US)

Correspondence Address: Daniel J. Wipper, 719 East Boulevard, McHenry, IL, 60051, US

(21) Appl. No.: 12/082,730

(22) Filed: Apr. 14, 2008

(51) Int. Cl. F21V 21/00

(52) U.S. Cl. 362/396

(57) ABSTRACT

The shade supporting device of this invention attaches a shade of various styles to the glass tube portion of a spiral shaped compact fluorescent light.

### FIELD OF THE INVENTION

The present invention relates to a method for providing a spiral shaped compact fluorescent light with a shade support and shade. More particularly it relates to attaching a shade supporting device directly to the spiraled glass tube portion of a compact fluorescent light.

### BACKGROUND OF THE INVENTION

The present invention relates to an accessory for a spiral shaped compact fluorescent light. Because of the unique and complex structural features of the new spiral shaped light, special considerations had to be given that would work on these surfaces in accordance to this invention. Presently some compact fluorescent lights come with a decorative cover that make them look more like a traditional bulb or globe shaped light though this cover is attached at the base, limited in style, not reusable, and traps heat that may shorten the life of the light.

### U.S. PATENT DOCUMENTS

20030001504 1/2003 Yu
20040109317 6/2004 Ribarich
Patent 20030001504 Yu describes a reflector for a compact fluorescent light that connects to the base of the light.
Patent 20040109317 Ribarich describes an integrated cover that attaches to the base of a compact fluorescent light.

No previous patents are cited for a shade support that utilizes the glass tube portion of a spiral shaped compact fluorescent light. There are no known previous claims that disclose the unique benefits claimed in the present Wipper invention.

### SUMMARY OF THE INVENTION

It is a primary objective of the present invention to provide a means to attach a shade to a compact fluorescent light, utilizing the spiral shaped glass portion of the light to support a shade. It does this to hide the spiral shaped glass portion with an aesthetically pleasant shade.

It should be noted that there is more than one way to accomplish the task of this invention. The most practical ways to accomplish this task are disclosed though it would be apparent to someone skilled at the art that other devices could be fashioned that utilize the common generic methods of this invention.

### DETAILED DESCRIPTION OF THE INVENTION

It is the main objective of this invention to provide a compact fluorescent light with a means to physically support a shade utilizing only the glass tube portion of the light. Other secondary objectives would be to provide a shade support of this type that is reusable, provides multi directional support, provides ventilation of heat, minimizes its own shadows, requires no tools for assembly or adjustment, and offers a variety of changeable styles and colors. Designs that constitute as forms of this invention, that disregard the secondary objectives, were not listed. The methods given as examples include the main objective of this invention while also considering the secondary objectives.

The invention accomplishes its objectives by mechanically attaching a shade support to the spiraled glass tube portion of a compact fluorescent light.

Different mechanical devices were fashioned that conform to generic features as described in claim one of this invention. They all utilize a spiral shaped compact fluorescent light's glass tube to provide support for a shade. These shade supports could utilize the glass tube's somewhat straight end portion, spiraled portions, or both portions to maximize support. In some designs herein, the outer surfaces of the spiraled portion of the light may be substituted for places where the interior surfaces were used though the interior surfaces were chosen to avoid shadows on the shade. A shade support of this invention may fasten, use spring tension, friction, adhesives, or shrinkable materials to attach to the glass tubing and provide support for a shade. Friction and clip style fasteners were used to provide for a product that is easy to use though these methods could be replaced by any number of mechanical fasteners that are on the common market. Each design of shade support may be permanently attached to the shade or be made removable and provided with a means for attaching and removing the shade. The various methods described within were chosen to display a wide variety of generic methods to accomplish the task of this invention. It would be obvious that combinations of these methods could be used to create many hybrid variations that would still constitute as generic versions of this invention.

### BRIEF DESCRIPTION OF THE DRAWINGS

FIG. 1 depicts a shade support that attaches to the glass tube portion of a compact fluorescent light.

FIG. 2 is the top view of the shade support in FIG. 1.

FIG. 3 is another view of the shade support in FIG. 1 which has been turned on its axis 90 degrees.

FIG. 4 depicts a shade support similar to FIG. 1 without supporting fingers #4 and utilizes only the glass tube's somewhat straight end portion to hold a shade.

FIG. 5 depicts the shade support of FIG. 4 which has been turned on its axis 90 degrees.

FIG. 6 depicts a shade support similar to FIG. 1 that utilizes a variation of supporting fingers #4.

FIG. 7 depicts the shade support of FIG. 6 which has been turned on its axis 90 degrees.

FIG. 8 depicts a shade support that attaches to the lower outer spiral of glass tubing and uses area #9 of the light to provide lateral support.

FIG. 9 depicts the shade support of FIG. 8 which has been turned on its axis 90 degrees.

FIG. 10 depicts a shade support similar to FIG. 8 that attaches to the upper outer spiral of glass tubing.

FIG. 11 depicts the shade support of FIG. 10 which has been turned on its axis 90 degrees.

FIG. 12 depicts a shade support that utilizes only the outer spiraled glass portion of a compact fluorescent light to provide support for a shade. A clear expanding sleeve and friction provide the means to attach a shade to the light instead of fasteners. It also depicts a shade support that is permanently attached to a shade.

FIG. 13 depicts another way to design a shade support similar to FIG. 12.

FIG. 14 depicts a shade support similar to FIG. 13 with a removable shade.

### REFERENCE NUMERALS IN DRAWINGS

1. The entire main portion of the shade support.
2. The means for providing a way to attach a shade to a shade support.
3. The means for attaching a shade support to the spiral shaped compact fluorescent light.
4. The means for providing lateral support by contacting the spiral portion of the light.
5. A relief area that accommodates the protruding bump #10 on a spiral shaped compact fluorescent light.
6. A fastener for attaching a shade to the shade support.
7. An optional offset washer.
8. A shade.
9. The somewhat strait end portion of a spiral shaped compact fluorescent light's glass tube.
10. The light's protruding manufacturing bump in its glass tubing.
11. The Edison style end of the light.
12. Glass tube portion of a spiral shaped compact fluorescent light.
13. Surfaces which are able to contact area #9 of a light at variable points.
14. The means for providing lateral support by contacting area #9 of the light.
15. Venting
16. One of many expansion slots.
17. An optional spacer

### DETAILED DESCRIPTION OF THE PREFERRED EMBODIMENTS

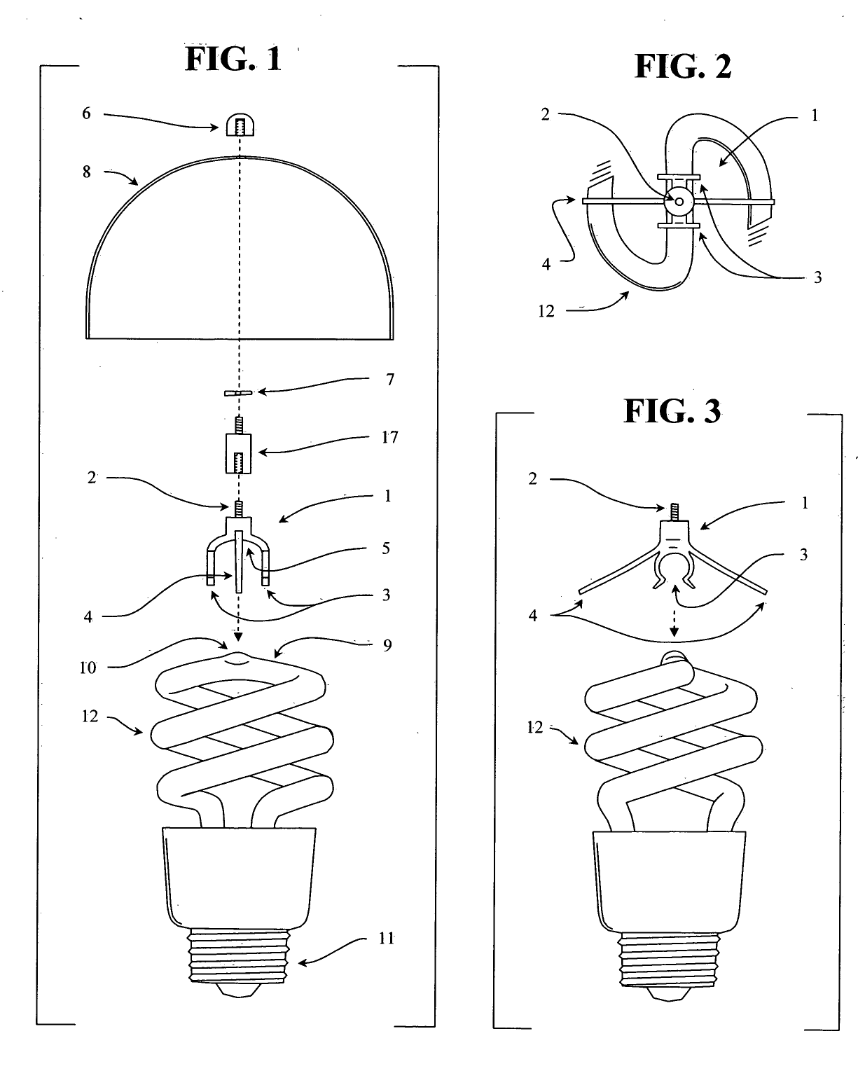

FIG. 1: FIG. 1 depicts a shade support #1 that utilizes a spiral shaped compact fluorescent light's glass tube #12 to provide support for a shade #8. This style of shade support utilizes a polarity of two open ended spring tension clip fasteners #3 that attach to the somewhat straight end portion of the glass tube #9 farthest from the Edison portion #11 of the light. Relief area #5 provides room for bump #10. This two clip system allows for shade angle adjustment in two directions; one direction as the clips pivot on the axis of the tube the other by sliding the shade support back and forth along the length of the tube until one clip rides up on the tube's bump #10. Utilizing two fasteners also provides lateral support for the shade in one direction. An optional pair of fingers #4 can be used to provide lateral support in the opposing direction. Fingers #4 provide this support by contacting the outer spiraled glass tube portion of the light. A threaded fastener #6 provides the means for attaching a shade to the threaded portion #2 of the shade support. An optional offset washer #7 may be utilized if more angle adjustment is needed do to a malformed light tube. And optional spacer #17 may be utilized between the shade support and shade to increase the distance between the two.

FIG. 2 depicts a top view of the shade support in FIG. 1 which better displays the positions of clip fasteners #3 and support fingers #4.

FIG. 3 is another view of the shade support in FIG. 1 which has been turned on its axis 90 degrees and better displays the shapes of clip fasteners #3 and support fingers #4.

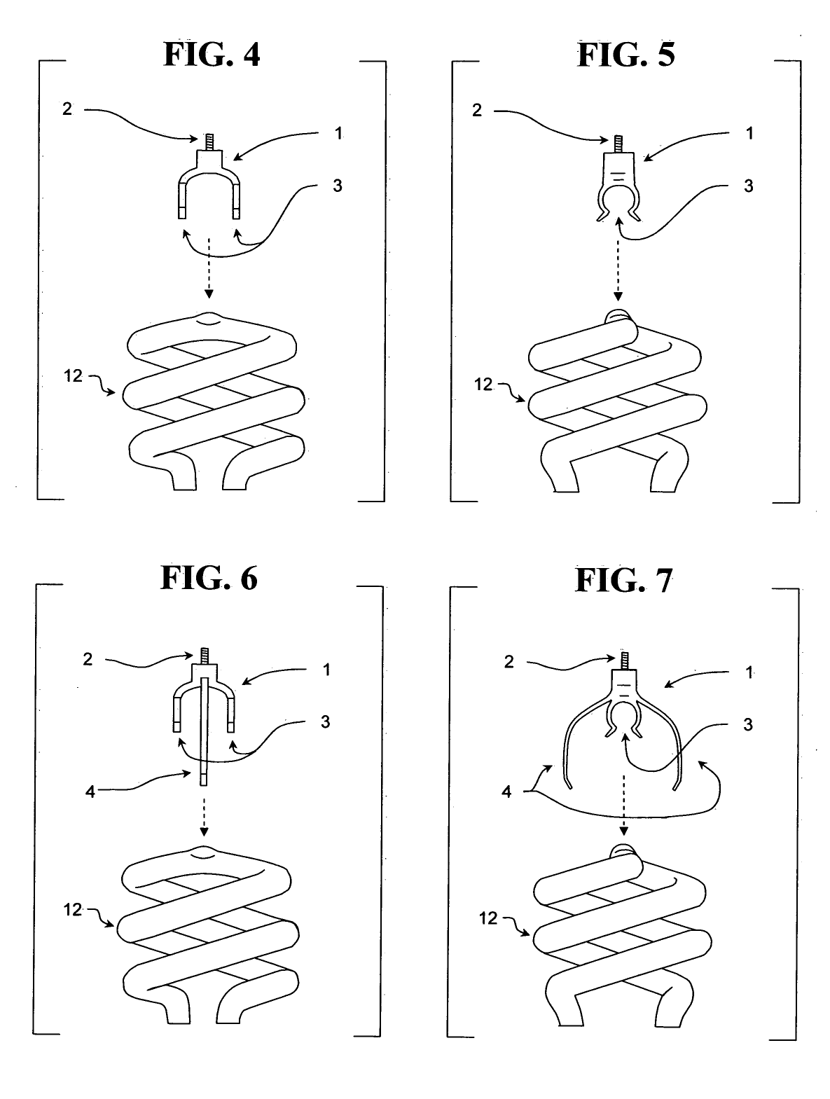

FIG. 4 Depicts a shade support #1 that utilizes a spiral shaped compact fluorescent light's glass tube #12 to provide support for a shade #8. The two fastener model of FIG. 4 is similar to the shade support in FIG. 1 though does not have the lateral support fingers. This version could also be designed with just one clip or fastener #3 that would represent the simplest form of this invention. In any case; a single elongated clip, fasteners with adhesive, a fastener built like a hose clamp, zip tie or any other common attaching devise could be utilized for additional support instead of having two fasteners. This simple approach in FIG. 4 may have limited lateral support and be best for lights that are used in the inverted position such as in ceiling fixtures.

FIG. 5 depicts the shade support of FIG. 4 which has been turned on its axis 90 degrees.

FIG. 6 depicts a shade support similar to FIG. 1 that utilizes a variation of supporting fingers #4.

FIG. 7 depicts the shade support of FIG. 6 which has been turned on its axis 90 degrees and better displays fingers #4 that provide additional support by contacting the interior side of the light's spiraled portion of glass tubing. This support could also utilize the exterior portion of the spiraled glass tubing though depending on the material used the supports may cause unwanted shadows on the shade.

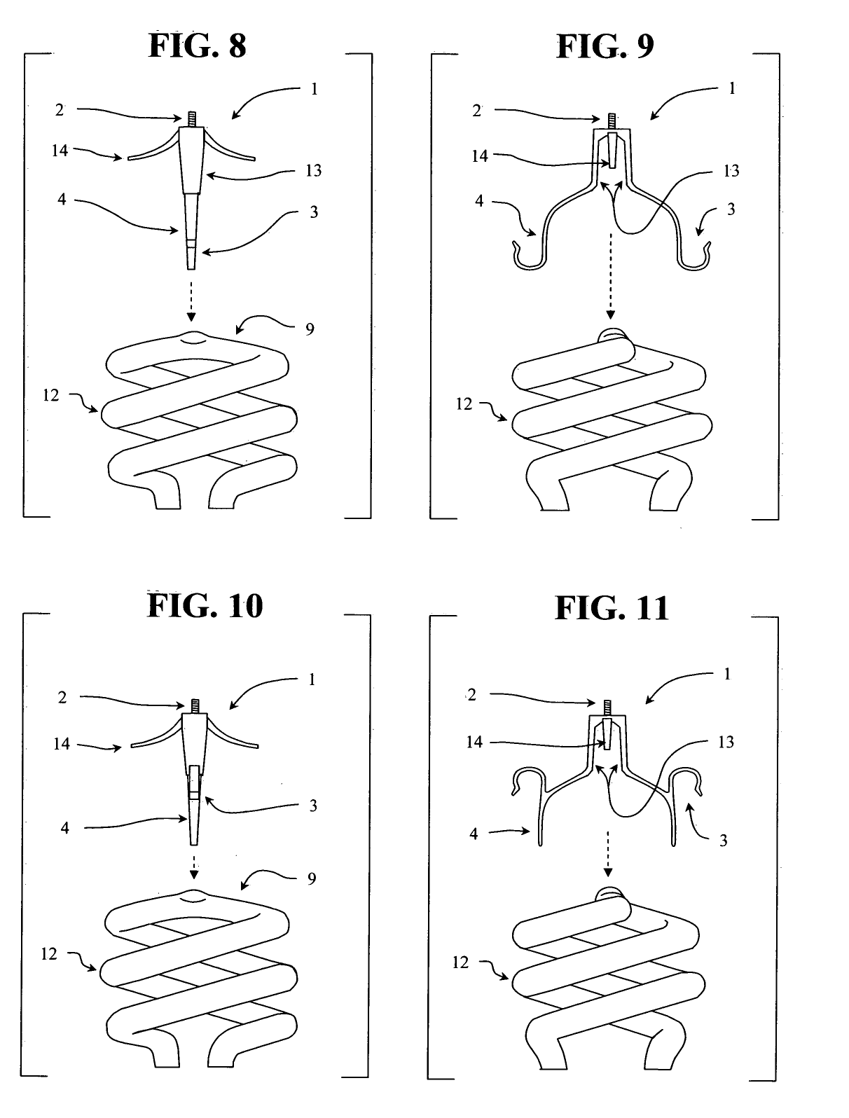

FIG. 8 depicts a shade support that attaches to the lower outer spiral of glass tubing of the compact fluorescent light. Surfaces #13 and fingers #14 may be added that would contact area #9 of the light to provide additional lateral support.

FIG. 9 depicts the shade support of FIG. 8 which has been turned on its axis 90 degrees and better displays clip fasteners #3 and surfaces #4 and #13. Area #13 could be provided with numerous devices that secure it to area #9 of the light after installing it to eliminate the need for fingers #14.

FIG. 10 depicts a shade support similar to FIG. 8 that attaches to the upper spiral of glass tubing.

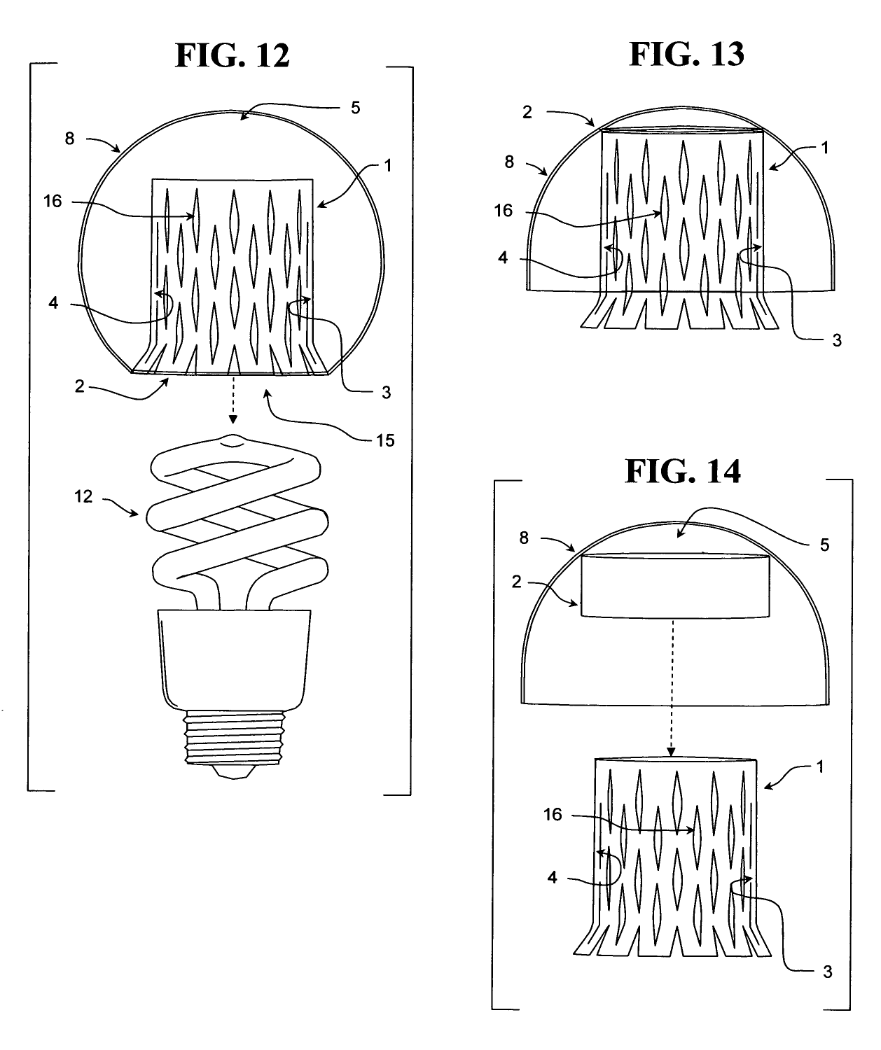

FIG. 11 depicts the shade support of FIG. 10 which has been turned on its axis 90 degrees and better displays clip fasteners #3 and surfaces #4 and #13. Surface #4 again utilize the interior portion of the glass spiral to eliminate unwanted shadows though could be designed to use the exterior portion as with any of the other shade support designs mentioned.

FIG. 12 FIG. 12 depicts a shade support part #1 that utilizes a spiral shaped compact fluorescent light's glass tube #12 to provide support for a shade #8. The shade support is a clear expanding sleeve and friction provides the means to attach a shade support to the light instead of fasteners. In this design only the outer spiraled glass portion of a compact fluorescent light is utilized to provide support for a shade. Numerous slots #16 provide the sleeve with its expandable characteristics. The material used for the sleeve will dictate the size, spacing, and number of slots needed and also its expansion, retraction, and spring like qualities. Heat that may damage the light can be vented out of area #15 unlike current shades that are sealed to the base of the light. It also depicts a shade support that is permanently attached to a globe style shade.

FIG. 13 depicts another way to design a shade support similar to FIG. 12 though it is permanently attached to the front portion of the shade.

FIG. 14 depicts a shade support similar to FIG. 13 that is provided with a removable shade. However, it was noted that the shade support's features in both FIGS. 13 and 14 produce noticeable shadows on the front portion of the shade.

While several embodiments of this invention have been described, various feature combinations for these shade supports may be combined to form other versions without departing from the main scope of this invention. Thus, the following variations of features for this invention are listed such that their use in different configurations may be readily understood.

ATTACHMENT DEVICES: The means for attaching a shade support to a spiral shaped compact fluorescent light's glass tube portion may be provided by any commonly available fasteners, adhesives, shrinkable materials, or friction creating devices that contact light's the glass tube.

RELIEF AREA: A relief area on a shade support that accommodates the protruding bump #10 on a spiral shaped compact fluorescent light.

SUPPORT FINGERS: Support fingers may be used on various portions of the lights glass tubing to provide additional support in certain directions. These fingers may be constructed out of somewhat flexible plastic, deformable metal or a combination of both.

ANGLE ADJUSTMENT: Shade angle adjustment can be provided by deformable fingers, offset mating surfaces or washers where the shade attaches to the shade support, sliding a surface that intersects with the light's center protruding glass bump or a fastener that pivots on the lights glass tubing. Or, a portion of shade support between the light and the shade could be made out of a deformable material.

VENTING: Venting is a naturally inherited feature of a shade support that utilizes the spiral glass tube portion of a compact fluorescent light for support. Shade supports that originate from the light's base would have to be provided with vents if this feature were desired.

SHADES: Shades may be permanently attached to the shade support or be removable and provided with a means for their attachment. This may be made out of any material and in many various styles, sizes, shapes, and colors. Shade supports of this invention could also be used with some common shades that are already on the market.

MATERIALS: Any material could be used for any part however; some materials may have certain qualities that may be better for certain reasons. The entire shade support may be made out of plastic or metal. Support fingers on a plastic shade support may be made out of or contain within deformable metal to add adjustability, producing a plastic and metal hybrid. This metal portion may have a deformed portion where it is embedded in the plastic so it can not move or spin freely on its axis.

SIZE: Different size shade supports could be designed for various sized lights. Depending on the style of shade supporting device one device might work on more that one sized light. The size of the stem that holds the shade may vary in length or have extensions added to it to change the distance between the shade and the light.

While several embodiments of this invention have been demonstrated it should be apparent to those skilled in the art that what has been described here is considered, at present, to be the preferred embodiments. There are many ways of executing the construction of a shade support for a spiral shaped compact fluorescent light that utilizes the glass tube portion of the light to support a shade. It would be possible to configure a shade support of this invention with many variations in parts, placements, angles, support fingers, and sizes, along with any common form of clips, clamps, adhesives or fasteners available. Parts and features described herein should be mixed and matched to form hybrid versions that would best execute each particular need for a shade's application.

In accordance with the Patent Statute, changes may be made in the shade support without actually departing from the true spirit and scope of this invention. The appended claims are intended to cover all such changes and modifications which fall under the overall scope of this invention.

What is claimed is:

1. A shade support that utilizes the glass tube portion of a spiral shaped compact fluorescent light to attach a shade to the light consisting of:
A. A said shade support.

2. A system of claim one wherein; the said shade support utilizes a fastener to attach to the center somewhat straight cross-member portion of a compact fluorescent light's glass tubing which; is farthest from the Edison style socket end of the light.

3. A system of claim two wherein; the said fastener utilizes another fastener or fasteners becoming a polarity of fasteners that are separated by a distance from each other by a fastener cross member.

4. A system of claim three wherein; the said fastener cross member is provided a relief area in its mid section that faces the light in order to accommodate room for the glass tubing's protruding manufacturing bump that is found on the end of most spiral shaped compact fluorescent lights.

5. A system of claim one wherein; the said shade support utilizes one or more finger member/s protruding from the device to provide opposing lateral support by contacting or attaching to opposing portions of the light's tubing.

6. A system of claim five wherein; the said finger member/s are manufacture out of a deformable material that allows for their adjustment and the adjustment of the shade's angle.

7. A system of claim one wherein, the said shade support is separate from the shade portion and provided with a means to attach a shade to the device.

8. A system of claim one wherein; the said shade support is an integrated part of the shade portion and after manufacturing is one part.

9. A system of claim one wherein; the said shade support's interface between itself and a shade is provided with a slight offset angle either in the surface of the shade and or said shade support or be provided in part or in whole by a separate offset washer having one portion thicker than the other placed between the two.

10. A system of claim nine wherein; the said offset washer is provided with a means for its adjustment after the shade is attached to the said shade support.

11. A system of claim one wherein; the said shade support is a clear tube that makes contact with and slides over the outer most portions of a compact fluorescent light's spiral glass tubing and uses this contact to provide support to attach a shade.

12. A system of claim eleven wherein; a polarity of many expansion slots in the said clear tube allow it to become an expandable tube that also supplies spring tension and friction.

13. A system of claim eleven wherein; the clear tube is made in part or whole out of a heat shrinkable material.

14. A system of claim one wherein; the said shade support utilizes a said fastener or said polarity of fasteners to attach to the spiraled portion of a compact fluorescent light's glass tubing.

15. A system of claims fourteen wherein; one or more surfaces of the said shade support make contact with the center somewhat straight cross-member portion of a compact fluorescent light's glass tubing.

16. A system of claims fourteen wherein; the said shade support is provided with fingers that make contact with the center somewhat straight cross-member portion of a compact fluorescent light's glass tubing.

17. A system of claim seven wherein; an extension spacer can be attached to the said shade support and then the shade attached to the said spacer.
